(19) United States
(12) Patent Application Publication
(10) Pub. No.: US 2019/0028589 A1
(43) Pub. Date: Jan. 24, 2019

(54) MULTIPLE PERSONALIZED GREETING MESSAGES FOR A VOICEMAIL SYSTEM

(71) Applicants: Kirk Schultz, Walled Lake, MI (US); Douglas Romanski, Milford, MI (US)

(72) Inventors: Kirk Schultz, Walled Lake, MI (US); Douglas Romanski, Milford, MI (US)

(21) Appl. No.: 16/137,107

(22) Filed: Sep. 20, 2018

Related U.S. Application Data
(63) Continuation-in-part of application No. 15/461,174, filed on Mar. 16, 2017, now abandoned.
(60) Provisional application No. 62/309,002, filed on Mar. 16, 2016.

(51) Int. Cl. H04M 3/533

(52) U.S. Cl. CPC H04M 3/53391

(57) ABSTRACT

A computerized process is operable upon a computerized telecommunications device and is configured to provide a personalized, contact-specific greeting to a caller contact. The process includes, within the computerized telecommunications device, operating programming configured to prompt a user of the device to record the personalized, contact-specific greeting, identify the caller contact based upon call data for an incoming call from the caller contact, and provide to the caller contact the personalized, contact-specific greeting based upon the identified caller contact. In one embodiment, every contact of the user can have a different greeting.

### CROSS REFERENCE TO RELATED APPLICATIONS

This disclosure is a continuation-in-part application of U.S. patent application Ser. No. 15/461,174 filed on Mar. 16, 2017 which claims the benefit of U.S. Provisional Application No. 62/309,002 filed on Mar. 16, 2016, both of which are hereby incorporated by reference.

### TECHNICAL FIELD

This disclosure is related to a computerized process to manage voicemail greetings for cellular accounts.

### BACKGROUND

The statements in this section merely provide background information related to the present disclosure. Accordingly, such statements are not intended to constitute an admission of prior art.

Cellular devices include a computerized processor, random access memory, and memory storage which collectively enable the devices to operate computerized programming to manage voice and data through the devices. Cellular devices manage using a voice mail account to receive voice messages for a user of the phone. A voice mail account includes a greeting or announcement that a caller hears providing information to the caller. After the greeting, the caller can be provided with the option of leaving a message for the owner of the cellular device.

### SUMMARY

A computerized process is operable upon a computerized telecommunications device and is configured to provide a personalized, contact-specific greeting to a caller contact. The process includes, within the computerized telecommunications device, operating programming configured to prompt a user of the device to record the personalized, contact-specific greeting, identify the caller contact based upon call data for an incoming call from the caller contact, and provide to the caller contact the personalized, contact-specific greeting based upon the identified caller contact. In one embodiment, every contact of the user can have a different greeting.

### BRIEF DESCRIPTION OF THE DRAWINGS

One or more embodiments will now be described, by way of example, with reference to the accompanying drawings, in which:

FIG. 1 illustrates an exemplary computerized process used to process incoming calls according to rules set for a plurality of voicemail accounts, in accordance with the present disclosure.

FIG. 2 illustrates an exemplary computerized process used to classify contacts according to caller type, wherein the types can be used to assign callers to one of a plurality of voicemail accounts, in accordance with the present disclosure.

FIG. 3 illustrates an exemplary computerized process used to process incoming calls according to defined caller types in order to assign an associated voicemail message to one of a plurality of voicemail accounts, in accordance with the present disclosure.

FIG. 4 illustrates an exemplary computerized smart phone device displaying voicemail message summaries from a plurality of separate, distinct voicemail accounts to a user upon a single display, in accordance with the present disclosure.

FIG. 5 illustrates an exemplary computerized smart phone device displaying options to a user for setting rules related to a particular caller type, in accordance with the present disclosure.

FIG. 6 illustrates an exemplary computerized smart phone device displaying options for a user to set message priorities by caller type, in accordance with the present disclosure.

FIG. 7 illustrates an exemplary computerized smart phone device displaying options for a user to enable and configure use of a plurality of voicemail accounts with the disclosed voicemail management system, in accordance with the present disclosure.

FIG. 8 schematically illustrates operation of an exemplary smart phone device including programming configured to operate the disclosed voicemail management system, in accordance with the present disclosure.

FIG. 9 schematically illustrates operation of a voicemail management application server, in conjunction with a user smart phone device, a cellular service provider, and a plurality of remote voicemail account providers, to provide coordinated access to the plurality of voicemail accounts from the single smart phone device, in accordance with the present disclosure.

FIG. 10 schematically illustrates operation of an exemplary voicemail management application server configured to operate the disclosed voicemail management system, in accordance with the present disclosure.

FIG. 11 illustrates an exemplary computerized smart phone device displaying options for a user to record a customized caller playback message for a caller type and/or individual members of the caller type, in accordance with the present disclosure.

FIG. 12 illustrates an exemplary computerized smart phone device displaying options for a user to select multiple preset and/or customized caller playback messages for and based upon a plurality of defined caller types, in accordance with the present disclosure.

FIG. 13 illustrates an exemplary telecommunications device displaying options for recording a customized caller playback message for a specific caller type and/or a specific contact, the playback message including options to set dates of operation, a duration of operation, and/or a number of maximum playbacks, in accordance with the present disclosure.

FIG. 14 illustrates an exemplary process to periodically or upon request update personalized greeting messages with the disclosed system, in accordance with the present disclosure.

### DETAILED DESCRIPTION

A computerized process for operation upon a cellular device is provided, wherein an incoming telephone call is classified and assigned to one of a plurality of voicemail accounts enabled upon or through the device.

The purpose is to allow a computerized process or application operating upon a single phone line cellular device or landline to differentiate between calls and provide customized voicemail response to each call depending on the categorization of the incoming call by the device user. This technology can be provided by a cell phone carrier, a cell phone manufacturer, a cell phone application programmer or provider, a landline service provider, or a standard telephone manufacturer (wired or cordless).

The disclosed system can operate as an exemplary telephone or digital device application that can be downloaded and utilized upon exemplary iOS® and Android® devices. Once enabled upon the device, the disclosed system permits the user to set up rules directing incoming cellular calls or directed voice messages to one of a plurality of distinct, separate phone message systems. Such phone message systems can be associated with a same or different cellular service provider, for example, with a “work” account being operated by wireless communications company A and with a “personal” account being operated by wireless communications company B.

An exemplary operating method is provided. A customer downloads the application on to a smart phone and installs the disclosed system embodied as a smart phone application. When the application is launched for the first time the user is prompted for registering for the service. The registration includes the customer choosing the mobile service operator from the list of operators. The application will use the mobile operators' service code to register for call forwarding to a Twilio® number given to the customer from the application. Upon confirmation of registration all calls will be forwarded to the Twilio® number.

The application allows for enabling and disabling the call forward facility. The customer can record voice messages and configure them to be used based on a rule. When caller calls the customer the chosen mobile service operator will forward the call to the enabled Twilio® number. Twilio® server will receive the call and transfers it to the Twilio® client on the phone. Twilio® customized IVR will call back application to identify which voice message to be provided based on rule for the incoming from number.

The recorded voice message is presented to the caller and voice message from the caller is recorded in the voice message box. The customer can configure how many times the call can be forwarded to custom message box. After the number of configured call forwards to the custom message box the application will disable the call forward number for Twilio®. The subsequent calls will be forwarded to the service provider default message box. Twilio® client will allow customer to access the voice message box to view and listen to the voice messages in the inbox.

Exemplary configuration of the disclosed system includes as follows. Contact information including telephone number is entered or loaded into the cell phone. Contact information can be manually input, downloaded through contact lists, complied through review of email list information, or both other similar means. The contact type can be designated by choosing any of the following non-limiting contact types (or contact list designations)—Spouse, Significant Other, Friend, Family, Work Associate, Supervisor, Customer, Potential Client, Generic, etc. and any other alphanumeric designation the phone owner desires. Such type designation can be made manually by user. In other embodiments, sampled text messages or emails to a contact can be used through methods such as machine learning algorithm processes to automatically assign either a type or a provisional type designation for a particular contact. For example, if the algorithm sees the word “golf” appear multiple times in text messages with Contact A, a prompt can be provided to the user, “OK to designate Contact A within the Friend message type?”

The contact type is assigned to a specific voicemail account of the phone owners choosing based on the voicemail account type that matches the contact designation.

When choosing the voicemail account, the phone owner chooses from the existing voicemail accounts or can press the ‘+’ and create a new, more specific voicemail.

The voicemail account can be labeled with any chosen alphanumeric description such as Personal and Work; Wife, Children, and Other; or Spouse, Significant Other, Friend, Family, Work Associate, Supervisor, Customer, Potential Client, Junk Mail, Etc. or can be given a person's name if the voicemail account is just for that person. A plurality of types can be directed or designated for a single account. For example, employees, contractors, and unknown business calls can be directed to one account labeled Normal Business, while calls from known clients, calls designated as referred from an advertising website, and calls from a particular state that frequently include prospective clients can be directed to a second account labeled Customers.

Each different voicemail account will have a unique message recorded by the phone owner for the specifically labeled voicemail. For example, the message for ‘Spouse’ could be personal or intimate, while the message for ‘Customer’ could be professional in nature, and the message for “Friend” could be comedic or humorous.

When a phone call comes in to the phone, if unanswered, it will go to the specific voicemail account designated for that contact by the phone owner based on information that can be determined according to the phone call, such as caller ID information designating the name or calling number of the call. If a call comes in from a ‘blocked’ number or from a number that does not yet exist in the specific cell phone contact data base, it will go to the one voice mail account designated as the default account by the phone owner—it could be Business, Friend or whatever the phone owner decides upon.

While the phone call, the message provided to the caller, and the storage of the left message can all be handled by the various distinct and separate message service providers or accounts, the disclosed system can index and provide for playback of the recorded messages upon a single display within a single application. When accessing the voicemail accounts for playback, the phone owner could have the voicemails listed in order received with a designation next to each voicemail telling what type it is to provide a visual aid to determine if the phone owner needs to listen to the message immediately or not. In another example, calls from a spouse can be given highest priority, always appearing at the top of the list, followed by calls from a work boss, with all remaining calls being sorted by time received.

The voicemails could also be grouped by voicemail type if the phone owner chooses depending on how the phone owner wants to access them.

Using multiple voice mail accounts enables a number of functions. One, it enables the user of a phone to preset a priority of a type of call. For instance, calls classified as “Friends” can disabled during the workday. In another example, when the phone is placed in “golfing” mode, calls from a type labeled “important clients” can be put through to the user while calls from “people that want to sell me stuff” can go into a voice mail account that does not ring the phone. In another example, voicemail options and data access can be segregated based upon the classification of the caller, for example, with a call from “wife” getting access to pictures on the cellular device and a voice activated shopping list, with “employees” getting access to work related files, and with “customers” getting access to information about products and services that the user of the phone provides as a business. A number of different functions enabled by the use of multiple accounts upon a cellular device are envisioned, and the disclosure is not intended to be limited to the particular examples provided herein.

The disclosed system permits operation of a plurality of separate, distinct phone message services or providers to be operated upon a single phone number and accessed by a single device. These separate accounts operable on a single device can have a number of additional benefits. One exemplary benefit includes unified administration of the various message accounts. While one may operate multiple devices, each with a message system included on each device, the present system enables a user once to enter a status or message, “I'm presently driving and cannot answer any calls—I will call you back shortly . . . ” By using the disclosed system administering to several phone massage accounts simultaneously, the user can set this status once and all incoming calls will immediately go straight to message and callers will be provided with such a status message without the user having to change settings on each of multiple message accounts. Similarly, new contacts created based upon new phone calls to the user are handled once by the system, with the user being assigned a type and/or a message account once.

Another benefit of the disclosed system includes unified access to multiple telecommunications systems and carriers. For example, a user may come into the system with three active Verizon Wireless® message accounts. The system administrator could negotiate offers from AT&T® and Sprint® carriers and periodically market these offers to the user, thereby aiding the user in getting the lowest prices possible. Additionally, new technology comes out frequently in the telecommunications industry, and the disclosed system can aid in rolling out this technology to users that might otherwise not take the time to investigate such developments. For example, the system can offer, “would you like me to translate your voice messages to text messages?” A user that did not know this was available can take advantage of this enhanced productivity tool through the disclosed system even through their current voicemail account company does not offer such a service.

Another benefit of the disclosed system is uncoupling a single voicemail system from a single telephone account. Presently, if a user signs up for cellular service, they get one voicemail account. Under the present system enabling easy access to multiple voicemail accounts simultaneously, a user might be able to get five voicemail accounts from database company A, five voicemail accounts from telecommunications company B, and five voicemail accounts from media/smart phone manufacturing company C, each costing some small amount each month to maintain, each receiving calls from a phone number operated by telecommunications company D, and each including benefits inherent to the particular company's strengths. For example, a database company might offer cheap storage of significant amounts of data, for example, enabling a parent to automatically save every message sent by a child away at school. A telecommunications company might offer discounts for additionally providing cellular service or might offer cutting edge technology. A smart phone manufacturer, such as Apple®, might offer cheap access to ringtones or other media/data services that the other companies might offer. in this way. the present system, by decoupling voicemail messages from a telecommunications cellular service. enables manipulation and operation of various types of voicemail accounts not presently available.

Another benefit of the disclosed system is ability to forward or change access to voicemail messages or voicemail accounts as modular or easily transferrable digital data. For example, a busy doctor may be at one office on Mondays and Thursdays, another office on Tuesdays and Fridays, and may teach at a university on Wednesdays. The present system can provide administrative assistants at each of the locations timely access to the doctor's voicemail messages, each assistant having selectable access from their normal, personal smart phone based upon the day of the week, as designated by the doctor. The doctor can segment which administrative assistant gets access to each type of contact, for example, with the doctor providing one assistant with access to only patient type messages, another assistant with access to patient and insurance provider type messages, and with the third assistant being given access to university and golf league type messages. In addition, the user can set rules with other parameters, for example, offering a spouse a “press 1 if this is important” message or, upon learning of a family illness, providing that family member with prioritized message importance for one week.

Another benefit of the disclosed system includes custom voice message box usage. A creative user can envision fifty different message types and employ fifty different message services. A college student could create fifty customized messages, one for calls from contacts from class A, another for calls from contacts from class B, another for calls from parents, another for calls from younger siblings, another for calls from sorority sisters, another for calls from boys, another for calls from university employees, another with a mechanical voice for calls from unknown sources, etc. As contacts change, e.g. a classmate becomes a friend, the type for a particular contact can be changed. In this way, a user can employ custom messaging to create desired effects upon multiple types of contacts.

Another benefit of the disclosed system is an ability to provide analysis/statistics for one or a plurality of users. For example, a boss managing a marketing team can receive a report for how many new contacts each of his/her employees has registered in their “customers” type, a report providing the numbers of each of those contacts, and how many calls the employee has received and made to each of those contacts as metrics to the performance of that employee. In another example, a user can look at how many marketing/junk mail messages were received in a particular time period and use that information to determine which contacts have been selling marketing information to mass marketing companies.

Another benefit of the disclosed system is an ability to provide enhanced security for sensitive information or personal identity details. For example, a security company such as Norton® or Lifelock® could provide a voicemail message service, utilizing expertise in their companies to screen new calls for a user, permitting messages to only be left in a screened and secure voicemail box until the user designates that contact as one to be trusted. Such a secure firewall would allow more casual use of voicemail systems, for example, enabling a user to provide callers with an optional automated mailing address recitation or whether the family is at the normal residence or the summer house, with the knowledge that only contacts cleared by the user through the security company will have access to those personal details.

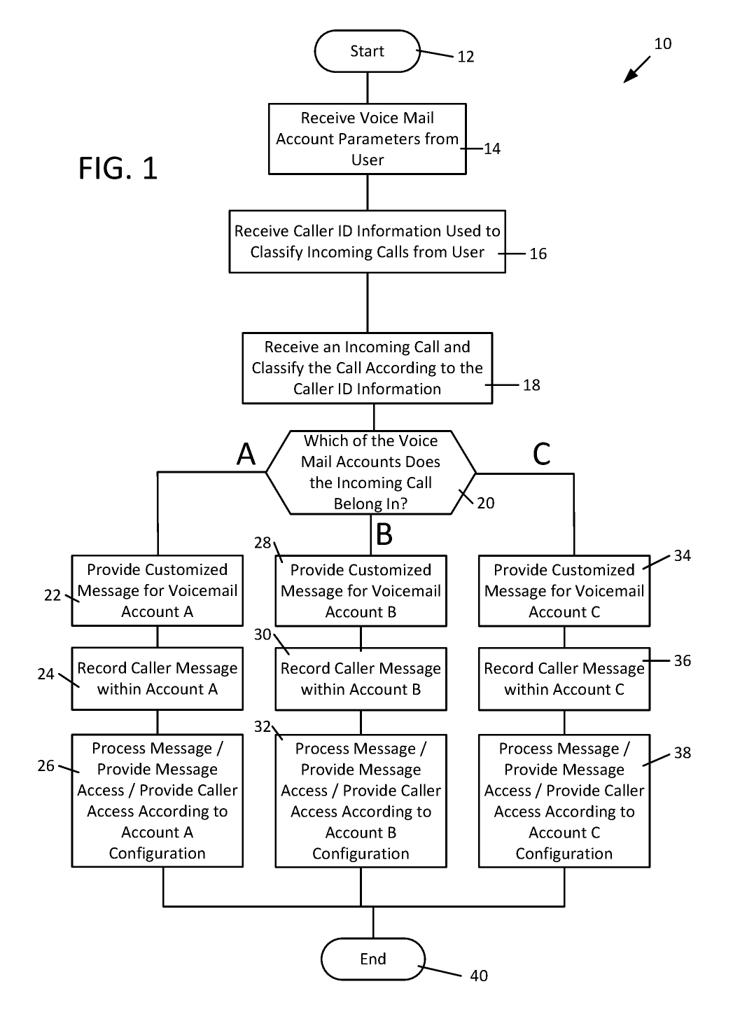

Referring now to the drawings, wherein the showings are for the purpose of illustrating certain exemplary embodiments only and not for the purpose of limiting the same, FIG. 1 illustrates an exemplary computerized process used to process incoming calls according to rules set for a plurality of voicemail accounts. Process 10 starts at step 12. At step 14, the system receives a voicemail account parameters for a plurality of accounts from a user including voicemail account access information and labels to be used with each voicemail account. At step 16, the system inputs caller ID information from the user that can be used to create rules for caller classification and distribution of voicemail service between the plurality of accounts. At step 18, the system receives a call and classifies the call according to the information provided in step 16. At step 20, the system determines which of three identified voicemail accounts, account A, account B, or account C, the received call should be directed to. If the call should be directed to account A, at step 22, the system provides a customized message for voicemail account A. At step 24, the system records a voicemail message from the caller within account A. At step 26, the system processes the message and provides access according to the configuration of account A.

If the call should be directed to account B, at step 28, the system provides a customized message for voicemail account B. At step 30, the system records a voicemail message from the caller within account B. At step 32, the system processes the message and provides access according to the configuration of account B.

If the call should be directed to account C, at step 34, the system provides a customized message for voicemail account C. At step 36, the system records a voicemail message from the caller within account C. At step 38, the system processes the message and provides access according to the configuration of account C. The process ends at step 40.

A user is provided options to set up a plurality of voice mail accounts and provide rules related to caller ID information in order to classify incoming calls. For example, specific phone numbers can be entered. In another example, area codes can be treated differently, with calls from a particular area code or codes being assigned to a particular account. In another example, caller ID information with particular words such as a political candidate's name or with the word marketing can be assigned to a particular account. After the process determines an appropriate account to send the incoming call to, the message and rules of the particular account are applied to the incoming call.

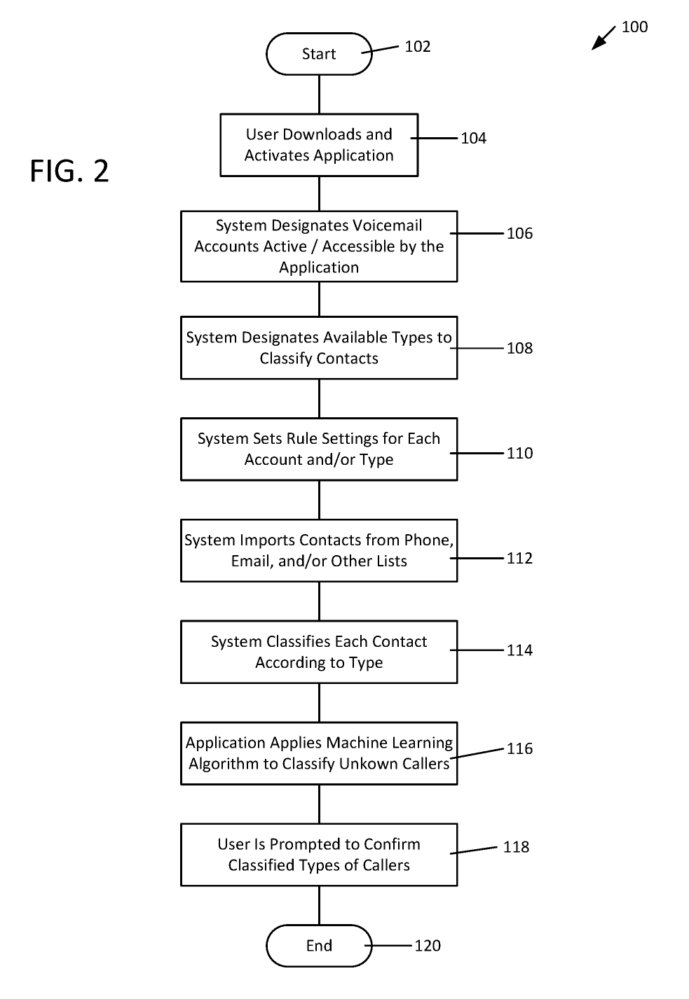

FIG. 1 describes an exemplary computerized process where each call is classified according to a set of rules based upon caller ID information. FIG. 2 illustrates another exemplary computerized process used to classify contacts according to caller type, wherein the types can be used to assign callers to one of a plurality of voicemail accounts. Process 100 starts at step 102. At step 104, the one downloads and activates the application. At step 106, the voicemail accounts are designated that are active or accessible by the application. At step 108, the options are provided for designating a plurality of caller types into which incoming calls can be classified. At step 110, options are provided to the user for selecting rule settings for each account and/or caller type. At step 112, the system imports contacts from a phone, an email account, and/or other computerized contact lists. At step 114, the system classifies each contact according to type. At step 116, the system employs an algorithm to classify or provisionally classify unknown callers into a caller type. According to one exemplary embodiment, the algorithm can include a machine learning algorithm configured to adjust over time and more accurately classify incoming calls from unknown callers. At step 118, the system prompts the user to confirm classified types of callers.

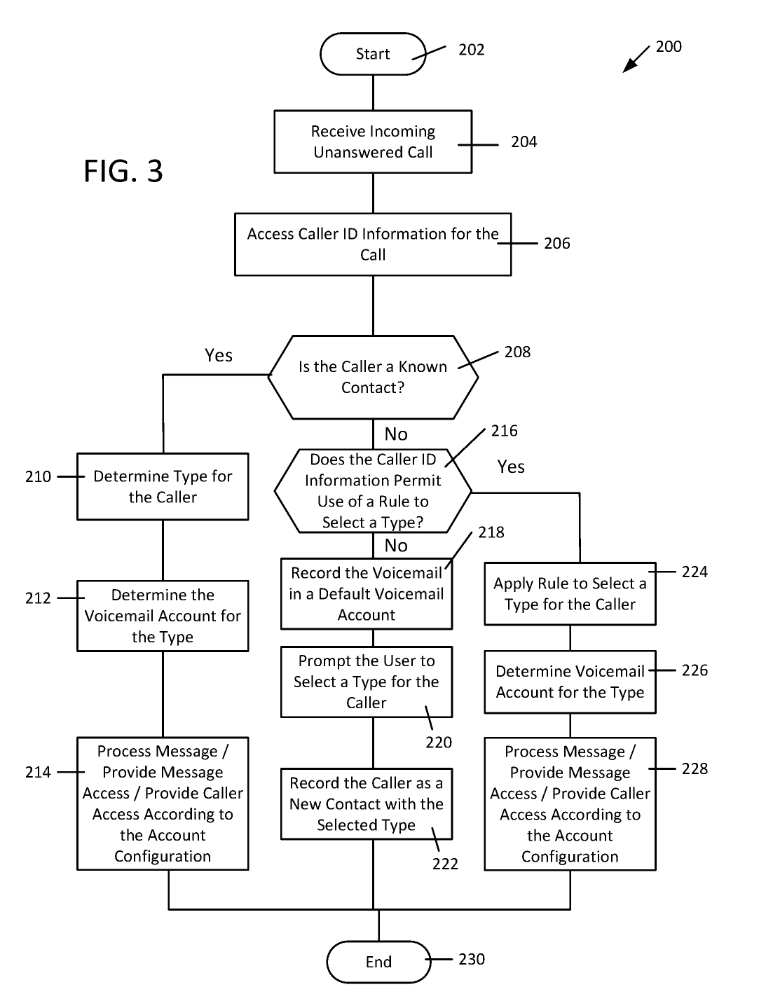

FIG. 3 illustrates an exemplary computerized process used to process incoming calls according to defined caller types in order to assign an associated voicemail message to one of a plurality of voicemail accounts. Process 200 starts at step 202. At step 204, the system receiving an incoming unanswered call. At step 206, the system accesses called ID information for the incoming call. At step 208, the system determines whether the incoming call is from a known contact. If the incoming call is from a known contact, step 210 determines a caller type for the caller. At step 212, the system determines a voicemail account for the caller type. At step 214, the system processes the message, including playing a customized caller playback message, records the message left by the caller, and provides access according to the configuration of the selected voicemail account.

If at step 208, the caller is not a known contact, the process advances to step 216, where the system determines whether the caller ID information for the incoming call is sufficient to permit classification of the incoming call within a particular caller type. If there is enough information to classify the incoming call, step 224 applies a rule to select a type for the caller. At step 226, the system determines a voicemail account for the selected caller type. At step 228, the system processes the message, including playing a customized caller playback message, records the message left by the caller, and provides access according to the configuration of the selected voicemail account.

At step 218, if the system does not have enough information to classify a type for the incoming call, the system records the voicemail of the incoming caller in a default account, at step 220, the user is prompted to enter a type for the recorded message and the associated caller, and at step 222 the caller is recorded with the type selected by the user. The process ends at step 230.

It will be appreciated that separate voicemail accounts can be configured and programmed within separate physical computerized devices. In another embodiment one or more voicemail accounts can be configured and programmed upon a single computerized device or server, with separate data files storing information on the same memory storage device with different file names or data details indicating that the data belongs to one voicemail account or another voicemail account.

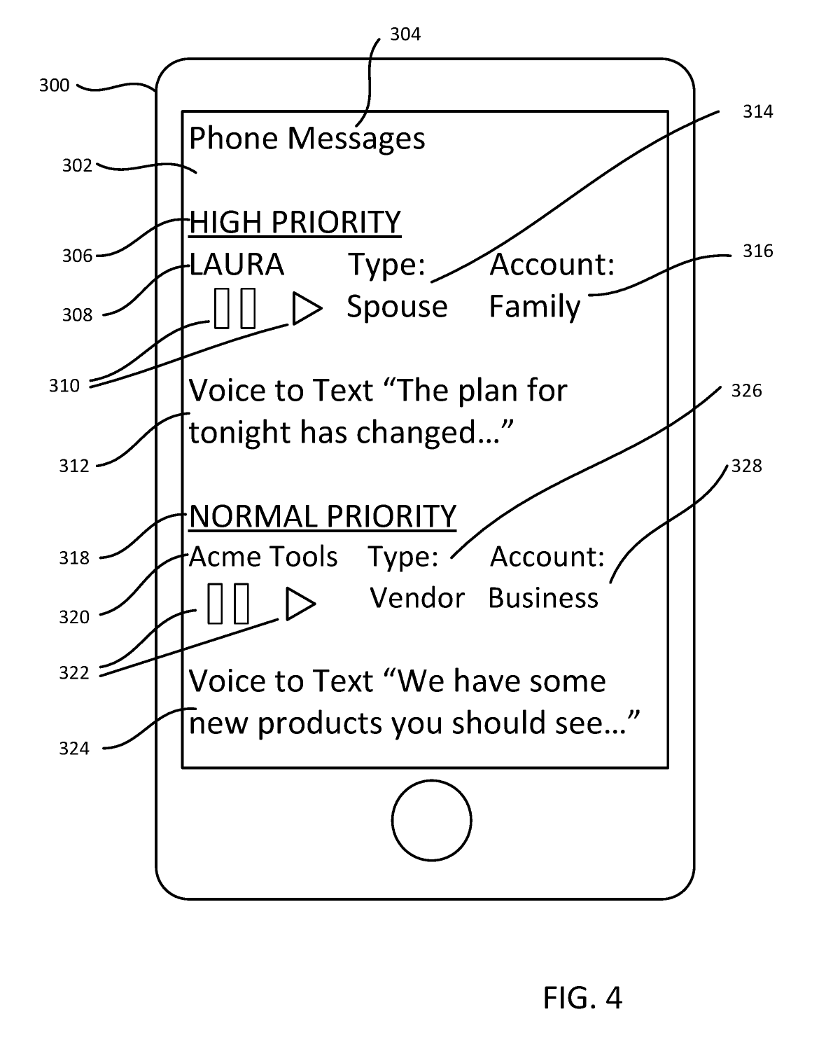

FIG. 4 illustrates an exemplary computerized smart phone device displaying voicemail message summaries from a plurality of separate, distinct voicemail accounts to a user upon a single display. Exemplary smart phone device 300 is illustrated including display 302. Banner 304 announces to the user that phone messages are being displayed. Text 304 illustrates a high priority message for review. Text 308 illustrates the name of the caller. Text 314 identifies the caller by identified type, in this case, as the spouse of the user. Text 316 identifies the voicemail account in which the message was recorded, in this case, within the account labeled “Family.” Optional text 310 includes a voice to text translation of a first or an identified important portion of the message which reads, “The plan for tonight has changed . . . ” Such voice to text translation is known in the art, and algorithms for identifying key aspects of a message are similarly known in the art. Icons 310 provide options for the user to play or pause audio playback of the message.

Text 318 identifies a second, normal priority message. Text 320 identifies the caller, which in this case is a company name. Text 326 identifies the caller type for the caller as a “Vendor” or a company that sells items or services to the user. Text 328 identifies the voicemail account in which the message was recorded, in this case, within the account labeled “Business.” Optional text 324 includes a voice to text translation of a first or an identified important portion of the message which reads, “We have some new products that you should see . . . ” Icons 322 provide options for the user to play or pause audio playback of the message.

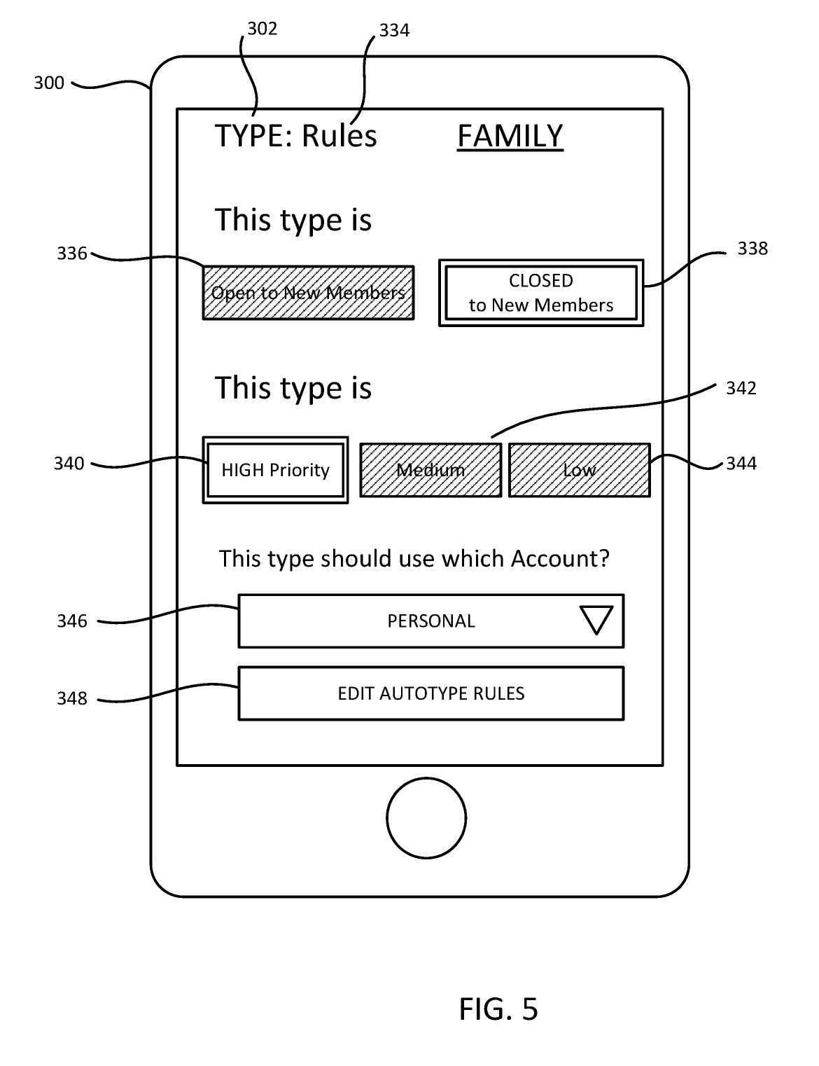

FIG. 5 illustrates an exemplary computerized smart phone device displaying options to a user for setting rules related to a particular caller type. Exemplary smart phone device 300 is illustrated including display 302. Banner 334 announces to the user that rules for the “FAMILY” type are being displayed for selection. Buttons 336 and 338 permit a user, respectively, to permit the type to be open or mandate that the type be closed to new members. If all members of an exemplary family are already included in one's Family caller type, the user can close new members from the type to avoid accidentally including non-family members in the call type. Buttons 340, 342, and 344 enable a user to select priority for a caller type as high priority, medium priority, or low priority, respectively. Button 346 enables the user to manually set the voicemail account for the selected caller type. Button 348 enables the user to set automatic type selection rules, for example, correcting tendencies of the system to assign callers to incorrect caller types.

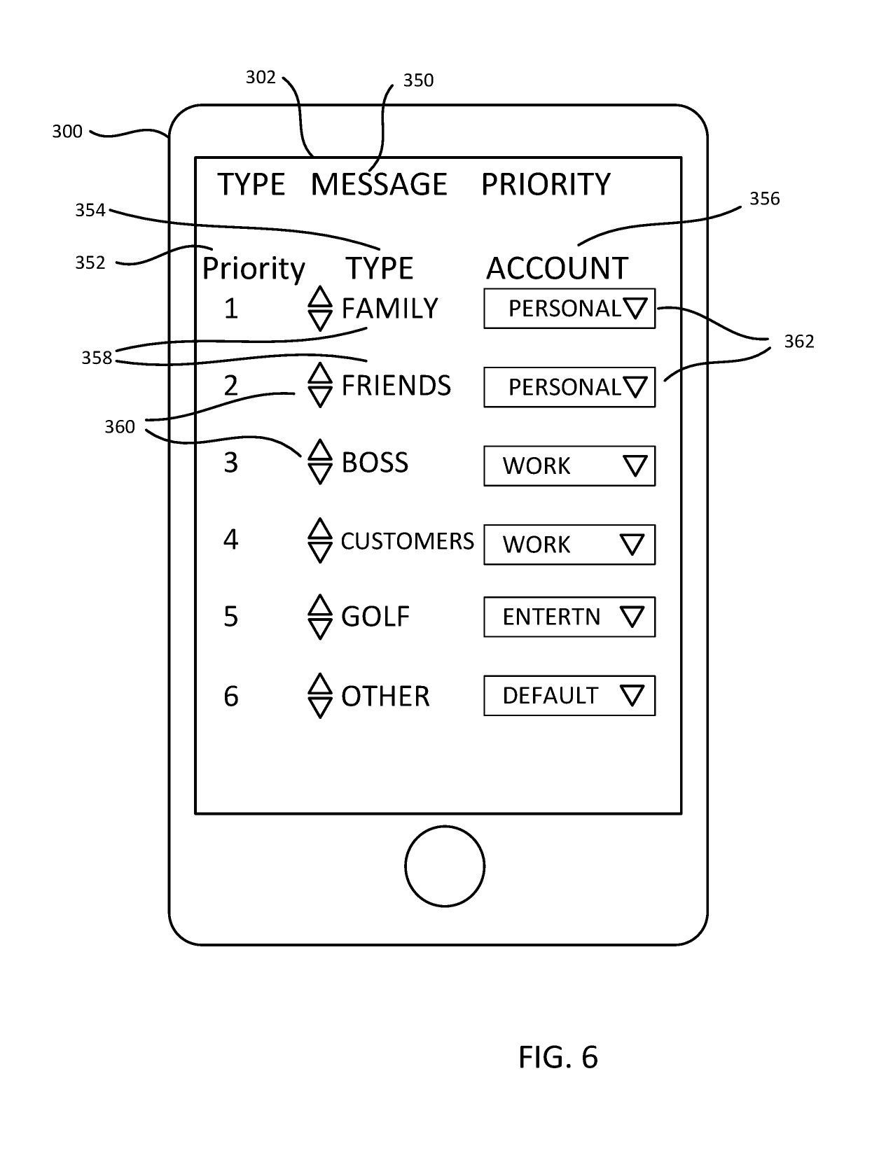

FIG. 6 illustrates an exemplary computerized smart phone device displaying options for a user to set message priorities by caller type. Exemplary smart phone device 300 is illustrated including display 302. Banner 350 announces to the user that priority of the various caller types is being displayed. Column 352 displays a priority of the various caller types, with a lower number indicating a higher priority. Column 354 lists the various caller types and includes icons 360 for adjusting a particular caller type up or down in message priority. Text 358 lists the particular type being compared. Column 356 lists the voicemail account that each type is linked to, and icons 362 permit the user to access a drop-down menu to change the associated voicemail account for any of the user types.

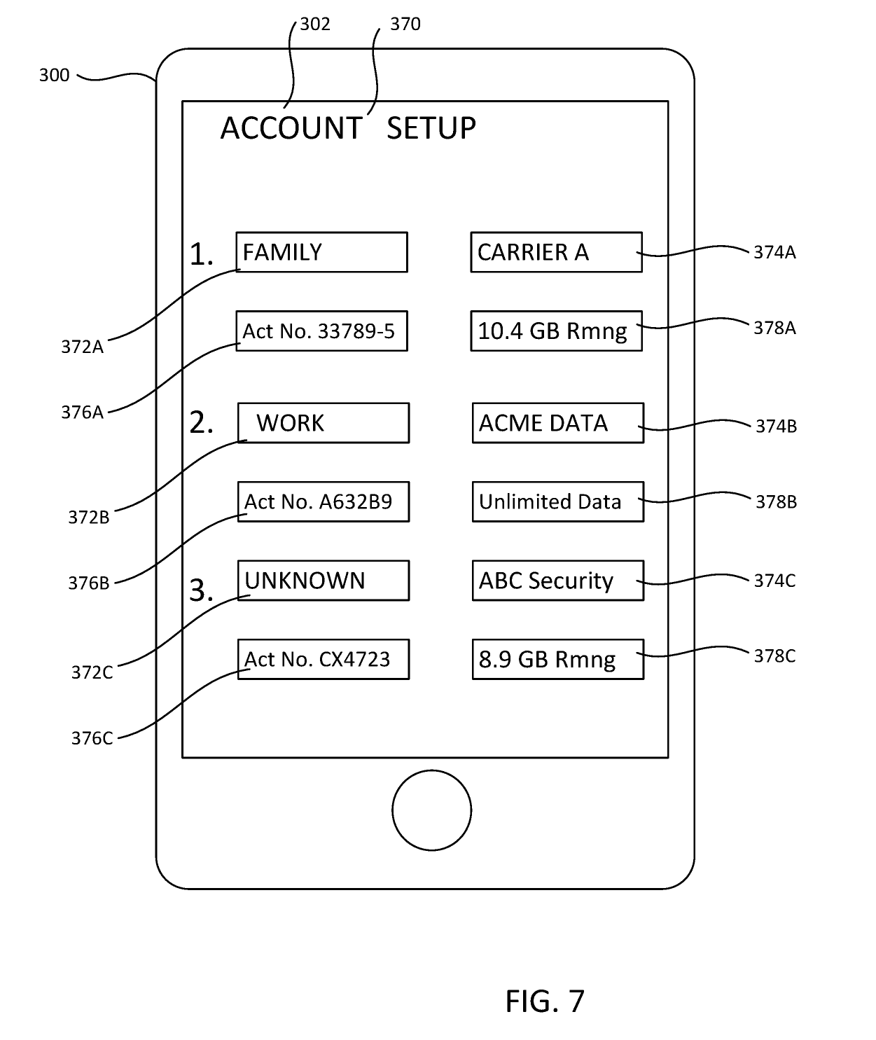

FIG. 7 illustrates an exemplary computerized smart phone device displaying options for a user to enable and configure use of a plurality of voicemail accounts with the disclosed voicemail management system. Exemplary smart phone device 300 is illustrated including display 302. Banner 370 announces to the user that voicemail account setup details are being displayed. Details 372A, 374A, 376A, and 378A illustrate respectively, the name assigned to each voicemail account, the account provider or company operating the voicemail account, the account number or identifying detail, and an optional measure of how much data remains to be used in the voicemail account. Details 372B, 374B, 376B, and 378B, and details 372C, 374C, 376C, and 378C each, respectively, convey similar details for a second and third voicemail account associated with the system. Each of the details can be simply for display or can include a button providing interactive details.

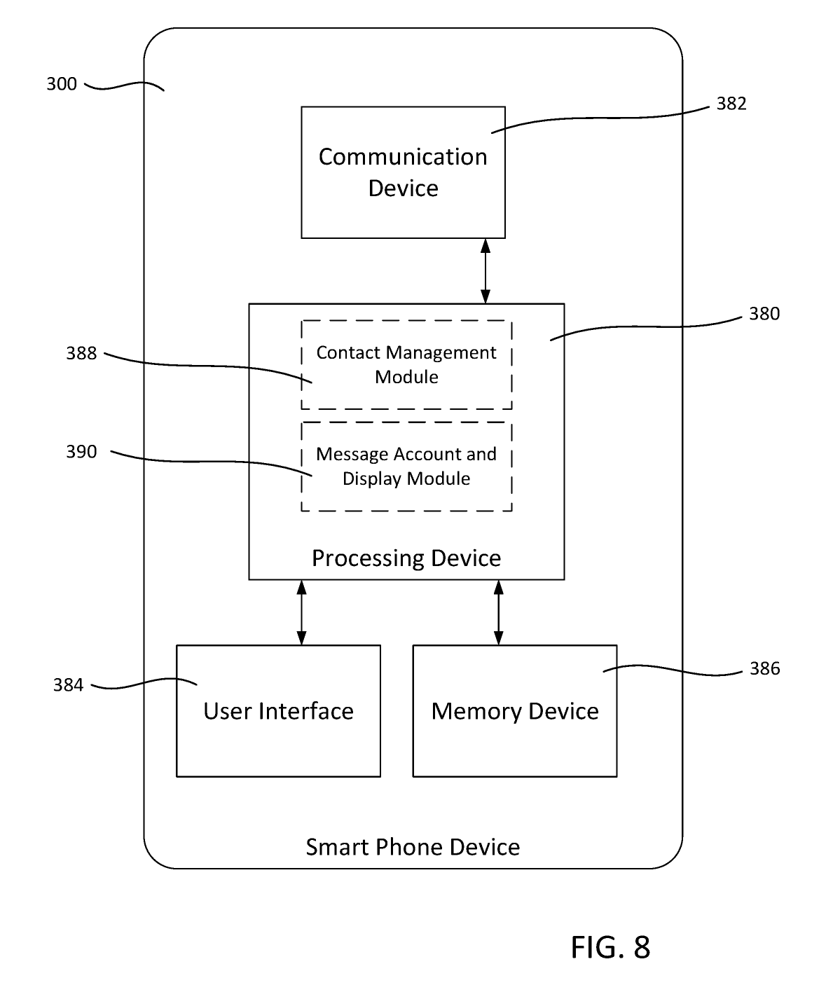

FIG. 8 schematically illustrates operation of an exemplary smart phone device including programming configured to operate the disclosed voicemail management system. Smart phone device 300 is illustrated, including an exemplary processing device 380, an exemplary communications device 382, an exemplary user interface 384, and an exemplary memory device 386.

Processing device 380 includes a processor or a plurality of processors that are capable of running computerized code or programming to execute commands based upon the programming. Device 380 can include one or more programming modules representing computerized code operating certain computerized instructions. Exemplary contact management module 388 enables details regarding contacts to be entered, stored, compared, and used according to the disclosed system. Exemplary message account and display module 390 enables selective details of voicemails and voicemail account details to be accessed, organized, and made available to the user according to the disclosed method. In one exemplary operation, module 390 enables a user to select between displaying active or new voicemail messages according to priority, timestamp, segmented according to voicemail account, segmented according to caller type, or other criteria. The operation of modules 388 and 390 is exemplary and include collectively programming required to operate the disclosed system.

Communication device 382 includes known computerized components for enabling smart phone 300 to communicate wirelessly with remote systems and devices according to methods known in the art.

User interface 384 includes display, microphone, speaker, touchscreen, and/or other components known in the art permitting one to communicate and make selections through a smart phone or similar telecommunications device.

Memory device 386 includes durable memory capable of storing data according to methods and devices known in the art, including but not limited to flash memory or a hard drive device.

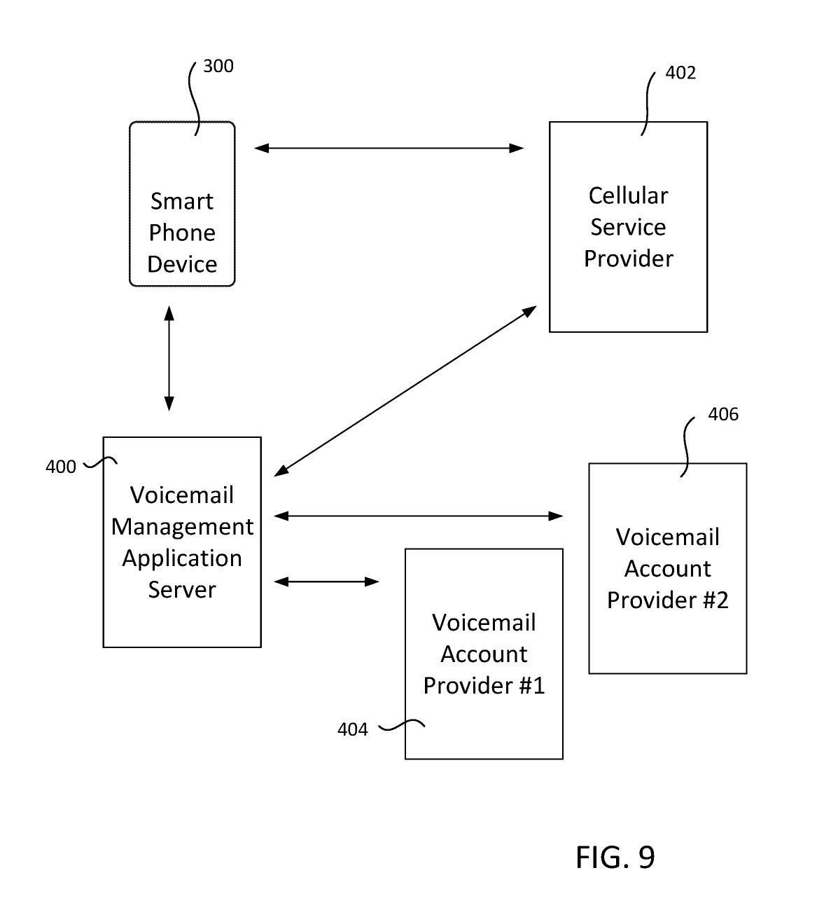

FIG. 9 schematically illustrates operation of a voicemail management application server, in conjunction with a user smart phone device, a cellular service provider, and a plurality of remote voicemail account providers, to provide coordinated access to the plurality of voicemail accounts from the single smart phone device. Smart phone device 300 is illustrated in communication with cellular service provider 402 and a voicemail management application server 400. Cellular service provider 402 provides telecommunication service, in the form of both voice and data, to smart phone device 300. Phone calls generated by other users are conveyed by provider 402 to smart phone device 300 as an incoming call. Cellular service provider 402 can optionally provide a built in voicemail account or accounts.

Smart phone device 300 is illustrated in communication with voicemail management application server 400 configured to operate computerized processes to operate the system disclosed herein, in cooperation with computerized processes installed upon smart phone device 300. Server 400 can but need not include built in voicemail accounts configured to operate with the disclosed system. Server 400 is illustrated in optional communication with two voicemail account provider servers 404 and 406. Servers 404 and 406 can each operated one or more voicemail accounts accessible by and configured to work with the programmed processes on server 400. Server 400 can access simultaneously voicemail accounts on any of server 400, servers 404 and 406, and cellular service provider 402.

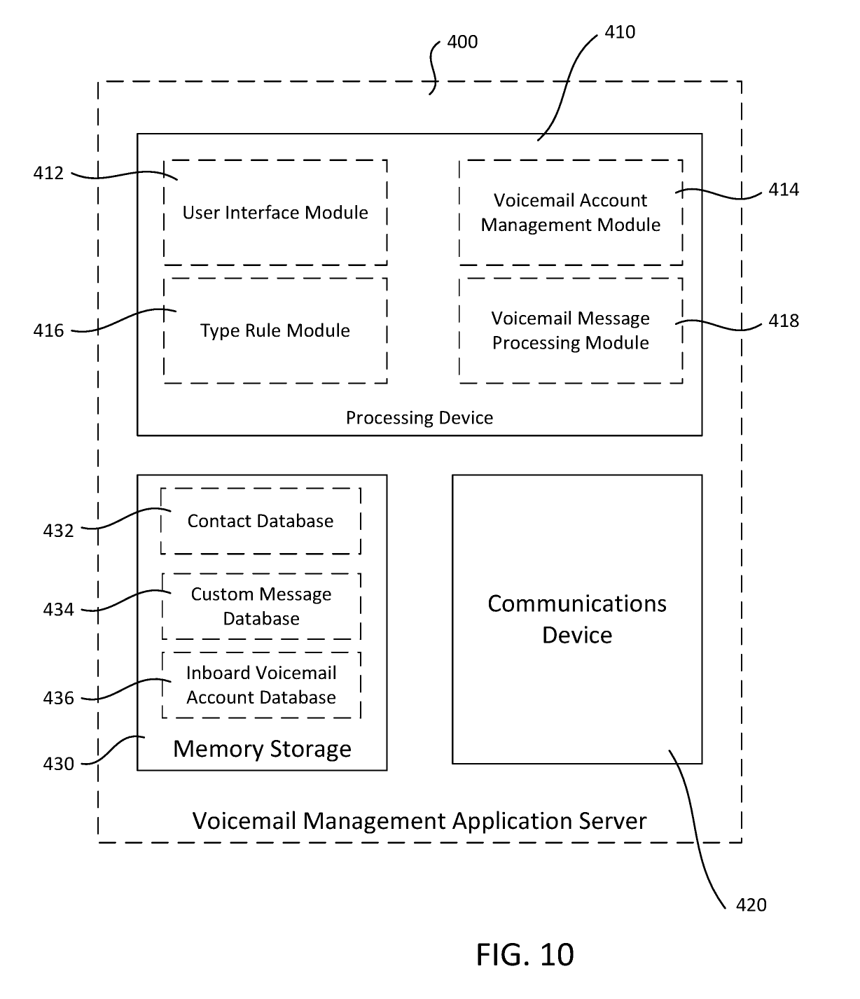

FIG. 10 schematically illustrates operation of an exemplary voicemail management application server configured to operate the disclosed voicemail management system. Voicemail management application server 400 is illustrated, including an exemplary processing device 410, an exemplary communications device 420, and an exemplary memory device 430.

Processing device 410 includes a processor or a plurality of processors that are capable of running computerized code or programming to execute commands based upon the programming. Device 410 can include one or more programming modules representing computerized code operating certain computerized instructions. Exemplary user interface module 412 provides communication configured to enable display and voicemail playback to the user's device and caller playback messages to callers making incoming unanswered calls. Exemplary voicemail account management module 414 includes programming required to communicate with, store upon, and retrieve from remote servers information necessary to operate the disclosed system. Exemplary type rule module 416 includes programming required to classify incoming calls into call types for the purposes of assigning the calls to one of the plurality of associated voicemail accounts. Exemplary voicemail message processing module 418 include programming required to process incoming calls, record customized caller playback messages, provide user control of the voicemail answering, recording, and playback processes. Operation of modules 412 is exemplary and collective combine to operate the system as disclosed herein.

Communication device 420 includes known computerized components for enabling server 400 to communicate wirelessly with remote systems and devices according to methods known in the art.

Memory device 432 includes durable memory capable of storing data according to methods and devices known in the art, including but not limited to flash memory or a hard drive device. Memory module 432 includes an exemplary contact database 432, an exemplary custom message database 434, and exemplary optional inboard voicemail account database 436.

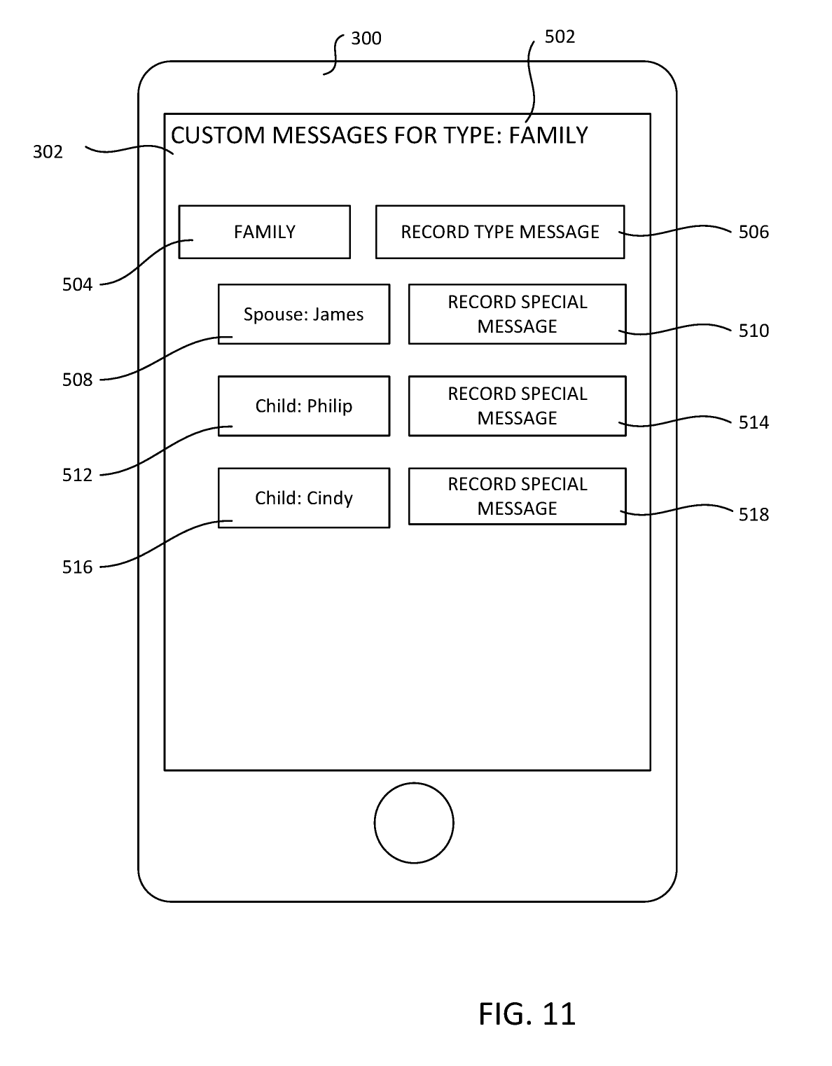

FIG. 11 illustrates an exemplary computerized smart phone device displaying options for a user to record a customized caller playback message for a caller type and/or individual members of the caller type. Smart phone device 300 is illustrated including display 302. Banner 502 announces to the user that custom messages for the caller type “FAMILY” is being displayed. Detail 504 identifies the caller type Family, and details 508, 512, and 516 identify individual contacts in the Family type. A button 506 is provided for recording a message for the entire Family type. Buttons 510, 514, and 518, are each provided, respectively, for leaving personalized caller playback messages for each member of the caller type.

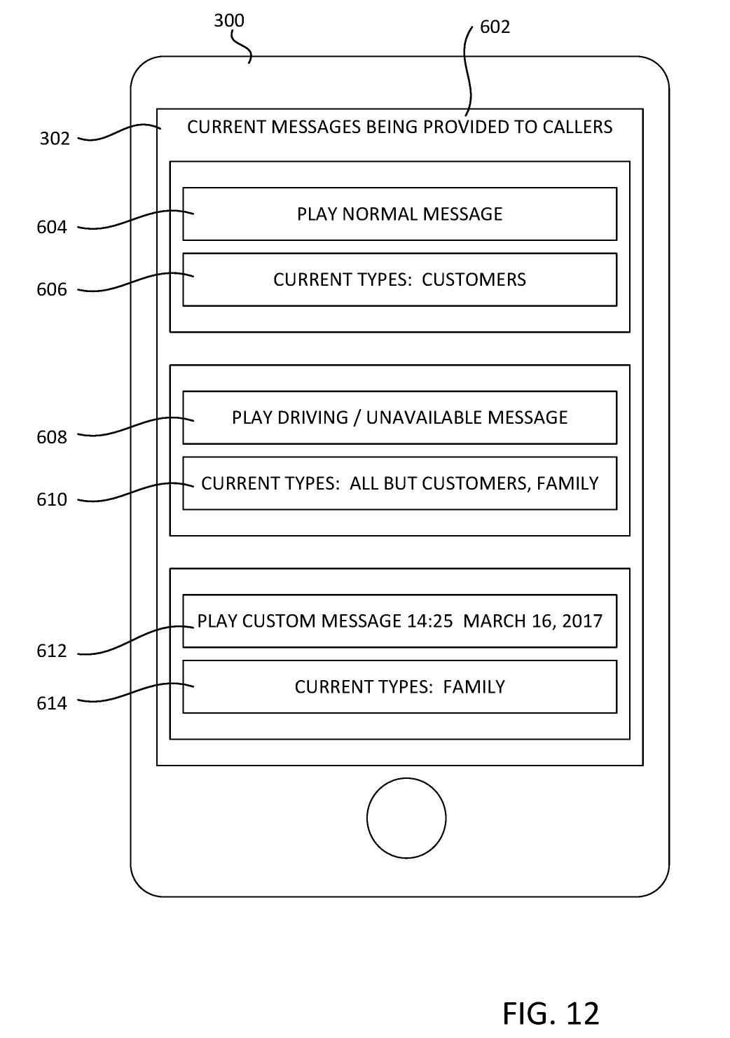

FIG. 12 illustrates an exemplary computerized smart phone device displaying options for a user to select multiple preset and/or customized caller playback messages for and based upon a plurality of defined caller types. Smart phone device 300 is illustrated including display 302. Banner 602 announces to the user that current messages being provided to different callers are being displayed. Button 604 identifies that a type or group of types is being provided a caller playback message labeled as “Normal Message.” Button 606 provides that the type labeled “Customers” is being provided the caller playback message of button 604. By clicking either button 604 or button 606, the user can be presented with options for either changing the message or changing the types being provided with the identified message. Similarly buttons 608, 610, 612, and 614 provide for one group of caller types receiving a “Driving/Unavailable” caller playback message and another group of caller types receiving a custom message recorded at a particular time and date.

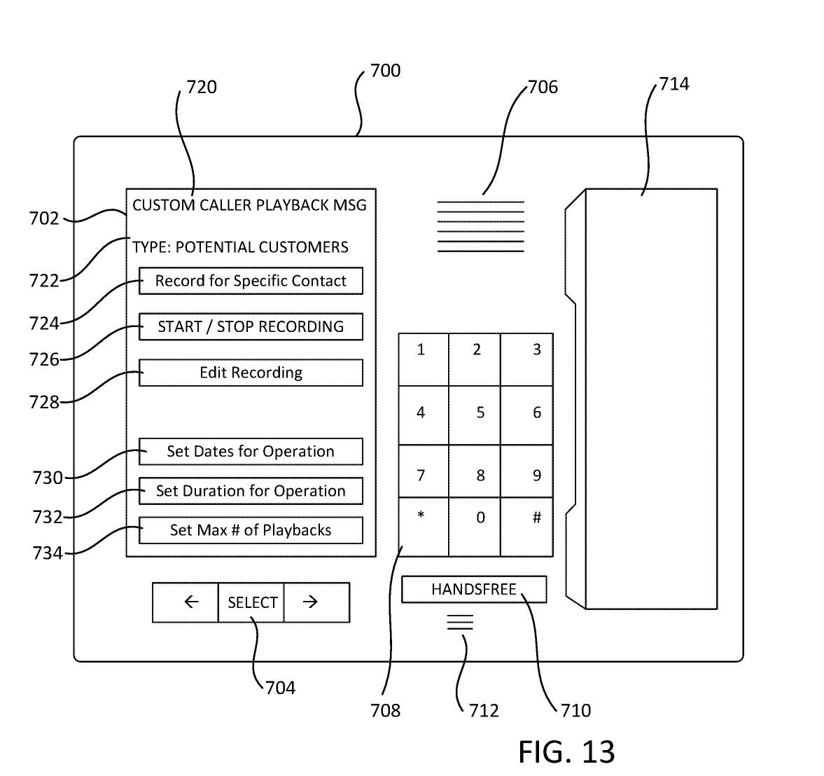

FIG. 13 illustrates an exemplary telecommunications device displaying options for recording a customized caller playback message for a specific caller type and/or a specific contact, the playback message including options to set dates of operation, a duration of operation, and/or a number of maximum playbacks. The disclosed system and associated processes can be operated upon any telecommunications device including an ability to operate the required programming. FIG. 13 illustrated exemplary desktop phone 700 including display 702, display manipulation buttons 407, speaker device 706, keypad 708, handsfree button 710, microphone 712, and handset 714. Display 702 includes banner 720 announcing to a user that a custom caller playback message is being created. Text 722 identifies a particular type that the message is being recorded for, although it will be appreciated that a message can be recorded for multiple types, individual or multiple contacts, or for later selection/association with types, voicemail accounts, or contacts. Button 724 enables the user to select a particular contact to associate with the message being recorded. Button 726 enables the user to start or stop recording the message. Button 728 enables the user to edit the recording, for example, permitting the user to trim the message or rerecord a portion of the message. Button 730 enables the user to set a span of dates for which the message will be operative. For example, if a salesman knows that a particular sale price will be active in two weeks, she can preset a message for operation during those days that the sale price will be active. Button 732 enables the user to set a duration of operation of the message, for example, leaving an out of the office message for the next 4 hours. Button 734 enables the user to set a particular number of playbacks for a particular message, for example, providing that a joke on the message will only be played once and discarded after the intended caller has heard the message.

The disclosed system enables unique and personalized greetings or announcements to be played for every caller. When a call is received by a telephone, existing caller ID technology can be used to determine whom the caller is. When an unanswered caller is identified, the disclosed system can direct the unanswered call to the voicemail greeting or announcement that is programmed for that caller.

The system would allow unlimited voicemail greetings—one per contact and also different announcements by category of contacts such as family-client-spouse-children-neighbor, etc. While known systems allow different rings to announce to the user different callers, the system gives out a unique voicemail announcement to each and every contact in your contact list if desired.

According to one embodiment, the user can selectively go through each entry in a phonebook and record greetings for each entry. According to another embodiment, as a new call is placed or received, the system can prompt the user to record a personalized greeting for each contact.

In another embodiment, contacts can be classified according to different groups (e.g., spouse, my children, my parents, my siblings, my boss, my coworkers, people that work for me, customers, etc.) Each group can be assigned a generic greeting which plays as a default greeting. The user can override the generic greeting for the whole group for a time. The user can override the generic greeting for a portion of the group for a time or permanently. The user can override the generic greeting for one contact in the group for a time or permanently.

In one embodiment, the system can include an automated daily service prompting the cell phone user to enter announcements for a portion of his or her contacts. For example, at 8 AM every day, the user's phone can ring, and upon answering, the user can be prompted to press one to enter daily greeting greetings, press two to skip entering greetings this day. Upon pressing one, the user can be prompted to enter personalized greetings for each of a group of pre-selected users. For example, a user can pre-select to enter personalized greetings for a husband, three employees, a boss, and a daughter every day. The system at a designated time will prompt the user to enter the daily greetings.

Personalized greetings further permit one to customize an experience for a user. For example, during an important golf outing with clients, a user can set up three tiers of greetings. For unknown or unimportant callers, a no-ring, standard greeting can be offered, with messages left by the caller going straight to an inbox. For pre-selected VIP contact callers, the phone can ring as usual, with a personalized greeting being played based upon the particular VIP. For a spouse or other very close person contact caller, a personalized greeting explaining the situation and offering a button to press to optionally cause the user's phone to ring (option provided to ring or not ring the user's phone) can be provided.

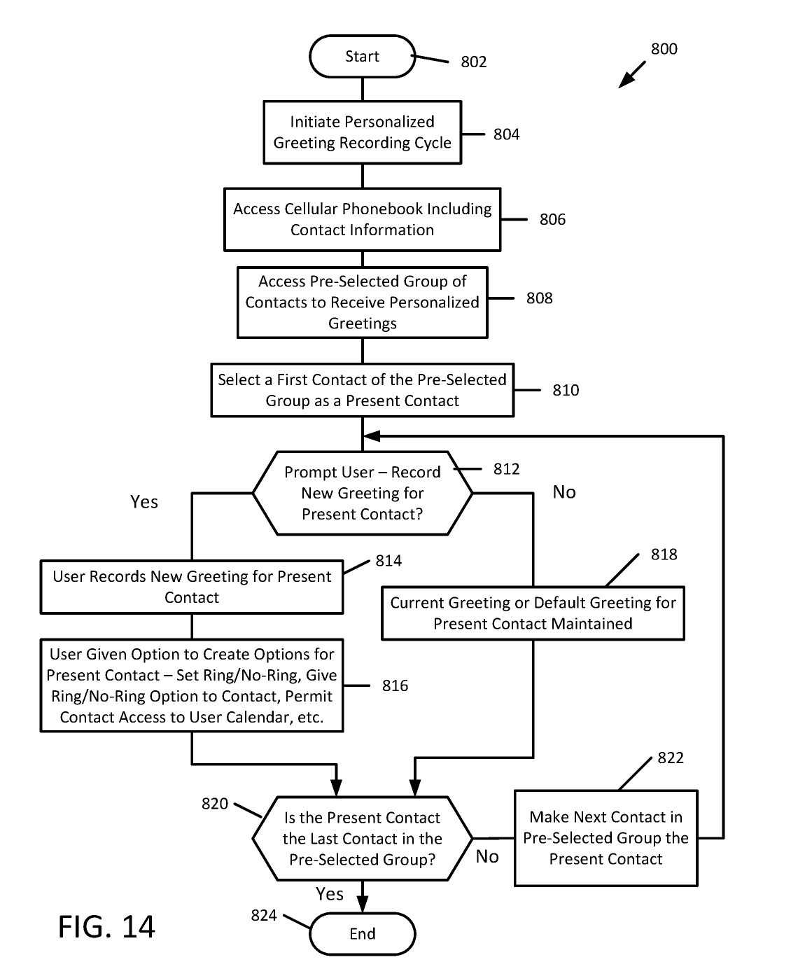

FIG. 14 illustrates an exemplary process to periodically or upon request update personalized greetings with the disclosed system. Process 800 starts at step 802. At step 804, a personalized greeting recording cycle is initiated. Such a cycle can be timed to start periodically, for example, daily or weekly, or such a cycle can be initiated at the request of the cell phone user or the request of an administrative assistant given authority to set the initiation. At step 806, the system accesses the phonebook of the cellular device (or of the user through access of a remote server storing the phonebook of the user) and accesses information about contacts of the user through the phonebook. At step 808, the system accesses a pre-selected group of the contacts of the user. This pre-selected group can be some or all of the contacts of the user. The user designates the contacts in this group as persons for whom the user wishes to record personalized greetings. At step 810, the system selects a first of the contacts in the group as a present contact. At step 812, the user is prompted whether to record a personalized greeting for the present contact. If the user designates yes, then the system advances to stop 814 where the user records a personalized greeting greeting and step 816, where additional options can be presented to the user. Such additional options can include setting a ring or no-ring option for the contact. A ring option means that the phone rings when the contact calls. A no-ring option sends the contact directly to voicemail without ringing the phone of the user. Alternatively, the user can select to give the ring and no-ring option to the caller/contact, such that the person calling can use their discretion whether they should bother the user, in light of the personalized greeting provided to the contact prior to making the selection of ring and no-ring. Alternatively or additionally, the user can provide the contact with access to an audio or graphical representation of the user's daily calendar, so that the contact can know when to call back. If the user, at step 812, designates no, then a current greeting or a default greeting for the contact is maintained. At step 820, a determination is made whether the present contact is the last contact in the pre-selected group. If the present contact is the last contact, then the process ends at step 824. If the present contact is not the last contact in the pre-selected group, then, at step 822, a next contact in the pre-selected group is selected as the present contact and the process returns to step 812 to iterate providing the option to record a personalized greeting for the new present contact. A number of alternatives to process 800 are envisioned, and the disclosure is not intended to be limited to the particular example provided.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A computerized process operable upon a computerized telecommunications device configured providing a personalized, contact-specific greeting to a caller contact, the process comprising:
within the computerized telecommunications device, operating programming configured to:
prompt a user of the device to record the personalized, contact-specific greeting;
identify the caller contact based upon call data for an incoming call from the caller contact; and
provide to the caller contact the personalized, contact-specific greeting based upon the identified caller contact.

2. The computerized process of claim 1, wherein the programming is further configured to prompt the user to record a personalized, contact-specific greeting for each contact in a phonebook of the user.

3. The computerized process of claim 1, wherein the programming is further configured to prompt the user to record a personalized, contact-specific greeting for each contact within a selected group of contacts in a phonebook of the user.

4. The computerized process of claim 3, wherein the programming is further configured to automatically prompt the user to record the personalized, contact-specific greetings periodically.

5. The computerized process of claim 4, wherein the programming is further configured to automatically prompt the user to record the personalized, contact-specific greetings daily.

6. The computerized process of claim 1, wherein the programming is further configured to selectively ring and not ring the device of the user based upon the identified caller contact.

7. The computerized process of claim 1, wherein the programming is further configured to provide the caller contact based upon the identified caller contact with an option to selectively ring and not ring the device of the user.

8. The computerized process of claim 1, wherein the programming is further configured to provide the caller contact based upon the identified caller contact with access to a calendar of the user based upon the identified caller contact.

9. A computerized process operable upon a computerized telecommunications device configured providing a personalized, contact-specific greeting to a caller contact, the process comprising:
within the computerized telecommunications device, operating programming configured to:
prompt a user of the device to record the personalized, contact-specific greeting for every contact in a phonebook of the user;
identify the caller contact based upon call data for an incoming call from the caller contact; and
provide to the caller contact the personalized, contact-specific greeting based upon the identified caller contact.
